(19) United States
(12) Patent Application Publication
(10) Pub. No.: US 2011/0072462 A1
(43) Pub. Date: Mar. 24, 2011

(54) System and Method to Modify an Electronic Program Guide

(75) Inventors: Scott White, Austin, TX (US); Ian Schmehl, Buda, TX (US); Thomas Sauer, San Antonio, TX (US)

(73) Assignee: AT&T INTELLECTUAL PROPERTY I, L.P., Reno, NV (US)

(21) Appl. No.: 12/564,979

(22) Filed: Sep. 23, 2009

(51) Int. Cl. H04N 5/445

(52) U.S. Cl. 725/41; 725/43; 725/131

(57) ABSTRACT

A computer-implemented method includes determining, at a set-top box device, first interaction data based on user interaction with a first portion of an electronic program guide that is displayable via the set-top box device. The computer-implemented method includes performing an analysis of the first interaction data and the first portion of the electronic program guide. The computer-implemented method also includes identifying a second portion of the electronic program guide based on the analysis. The computer-implemented method further includes modifying the electronic program guide to display the second portion of the electronic program guide adjacent to a location of the first portion of the electronic program guide.

### FIELD OF THE DISCLOSURE

The present disclosure is generally related to modifying an electronic program guide.

### BACKGROUND

A set-top box device may display portions of an electronic-program guide. The electronic program guide may identify media content that is available for viewing. A viewer may be interested in viewing a particular type of media content via the set-top box device. The viewer may spend time and effort interacting with the electronic program guide when attempting to identify portions of the electronic program guide that have the particular type of media content. The viewer may find it frustrating trying to identify the portions of the electronic program guide that have the particular type of media content when the electronic program guide displays a large amount of content (e.g. hundreds of channels).

### BRIEF DESCRIPTION OF THE DRAWINGS

FIG. 1 is a block diagram of a first particular embodiment of a system to modify an electronic program guide;

FIG. 2 is a block diagram of a second particular embodiment of a system to modify an electronic program guide;

FIG. 3 is a block diagram of a third particular embodiment of a system to modify an electronic program guide;

FIG. 4 is a block diagram of a fourth particular embodiment of a system to modify an electronic program guide;

FIG. 5 is a flow diagram of a first particular embodiment of a method to modify an electronic program guide;

FIG. 6 is a flow diagram of a second particular embodiment of a method to modify an electronic program guide; and

FIG. 7 is a block diagram of an illustrative embodiment of a general computer system.

### DETAILED DESCRIPTION

A set-top box device may determine interaction data based on user interaction with a first portion of an electronic program guide. The set-top box device may perform an analysis of the interaction data and the first portion of the electronic program guide. The set-top box device may identify a second portion of the electronic program guide based on the analysis. The set-top box device may modify the electronic program guide to display the second portion of the electronic program guide adjacent to a location of the first portion of the electronic program guide.

In a particular embodiment, a computer-implemented method includes determining, at a set-top box device, first interaction data based on user interaction with a first portion of an electronic program guide that is displayable via the set-top box device. The computer-implemented method includes performing an analysis of the first interaction data and the first portion of the electronic program guide. The computer-implemented method also includes identifying a second portion of the electronic program guide based on the analysis. The computer-implemented method further includes modifying the electronic program guide to display the second portion of the electronic program guide adjacent to a location of the first portion of the electronic program guide.

In another particular embodiment, a set-top box device includes a processor and a computer-readable storage medium including operational instructions that, when executed by the processor, cause the processor to determine user interaction data including first data associated with displaying channels of an electronic program guide. The user interaction data includes a predetermined number of user selections that include a most recent user selection. The computer-readable storage medium further includes operational instructions that, when executed by the processor, cause the processor to identify a recommended channel of the electronic program guide based on the user interaction data. The computer-readable storage medium further includes operational instructions that, when executed by the processor, cause the processor to modify the electronic program guide to display the recommended channel adjacent to a location of one of the channels.

In another particular embodiment, a set-top box device includes a network interface to receive media content from a media content server. The set-top box device also includes a display interface to send the media content to a display device and to display an electronic program guide based on a user profile. The set-top box device further includes a computer-readable storage medium including an analyzer module that when executed by a processor causes the analyzer module to determine first interaction data based on a first period of user interaction with a first portion of the electronic program guide, to identify a second portion of the electronic program guide based on the first interaction data, and to modify the electronic program guide to display the second portion of the electronic program guide adjacent to a location of the first portion of the electronic program guide.

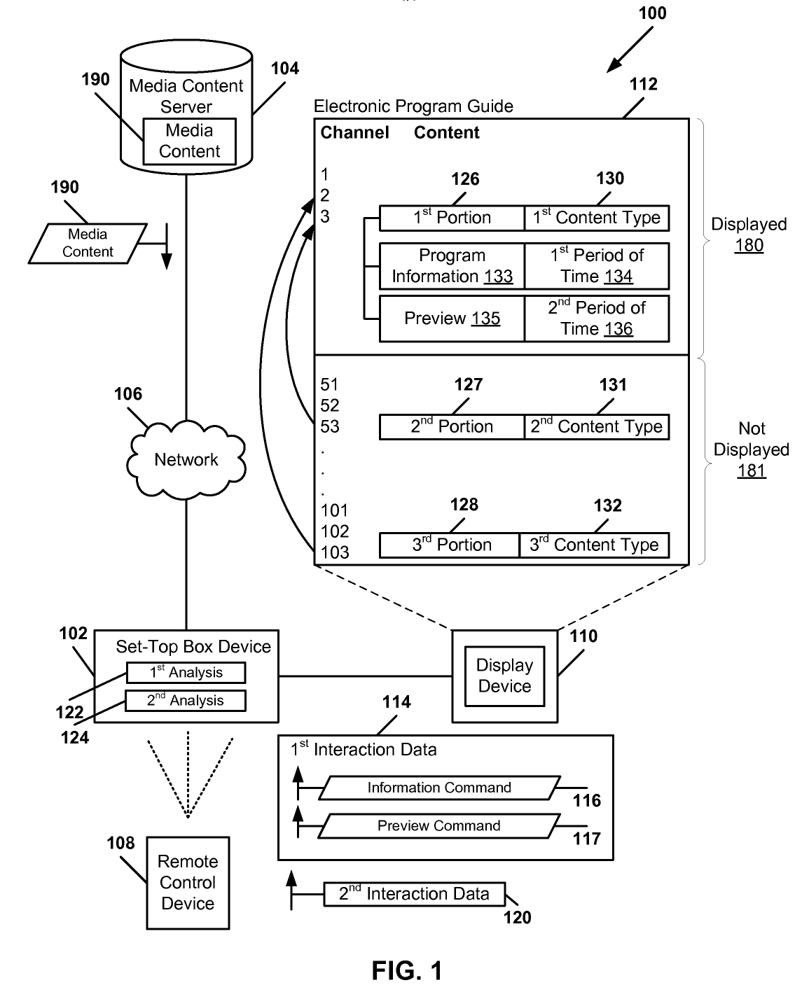

Referring to FIG. 1, a block diagram of a first particular embodiment of a system to modify an electronic program guide is depicted and generally designated 100. The system 100 includes a set-top box device 102 coupled to a media content server 104 via a network 106.

The media content server 104 may send media content 190 to the set-top box device 102 via the network 106. The media content 190 may include television programming content, movie content, video-on-demand content, over-the-top content, other media content, or any combination thereof.

The network 106 may include one or more transmission media, such as fiber-optic cable, Hybrid Fiber Coaxial (HFC) cable, twisted pair cable, wireless transmission media (e.g. 802.11 or 802.16), other transmission media, or any combination thereof. The network 106 may receive the media content 190 from the media content server 104 and may send the media content 190 to the set-top box device 102. In a particular embodiment, the network 106 is an Internet Protocol (IP) based network.

The set-top box device 102 may be coupled to a display device 110. The set-top box device 102 may display the media content 190 at the display device 110. A user (not shown) may interact with the set-top box device 102 via a remote control device 108. A first portion 126 of an Electronic Program Guide (EPG) 112 may be displayed 180 at the display device 110 by the set-top box device 102. A second portion 127 and a third portion 128 of the EPG 112 may be not displayed 180 at the display device 110 by the set-top box device 102.

The EPG 112 may enable a user to select content that is of interest to the user via the remote control device 108. The EPG 112 may also enable the user to find out more information about particular content listed in the EPG 112. For example, using the remote control device 108, the user may select an information command 116 to display program information 133 associated with the first portion 126 of the EPG 112. The first portion 126 of the EPG 112 may be a particular channel or set of channels having a first content type 130. Using the remote control device 108, the user may select a preview command 117 to display a preview 135 associated with the first portion 126 of the EPG 112.

In operation, the set-top box device 102 may determine first interaction data 114 based on the user interacting with the first portion 126 of the EPG 112. The first portion 126 may have an associated first content type 130, such as action, adventure, drama, news, sports, music, another content type, or any combination thereof. For example, the user may interact with the first portion 126 of the EPG 112 by selecting one or more of the information command 116 and the preview command 117. The set-top box device 102 may display program information 133 at the display device 110 in response to receiving the information command 116. The program information 133 may provide information associated with the first portion 126 of the EPG 112 such as a title, a partial list of actors and actresses, a running time, a summary, a content rating, other type of information associated with media content, or any combination thereof. The set-top box device 102 may display a preview 135 at the display device 110 in response to receiving the preview command 117. The preview 135 may be displayed for a second period of time 136. The preview 135 may enable a viewer to view selected parts of media content associated with the first portion 126 of the EPG 112.

The set-top box device 102 may perform a first analysis 122 of the first interaction data 114 and the first portion 126 of the EPG 112. For example, the first analysis 122 may identify the first content type 130 of the first portion 126 of the EPG 112. The first analysis 122 may identify that the set-top box device 102 received the information command 116 and may identify that the program information 133 was displayed for the first period of time 134 at the display device 110 after the set-top box device 102 received the information command 116. The first period of time 134 may be used to determine a weight given to the program information 133 when performing the first analysis 122. For example, when the first period of time 134 is relatively short (e.g. less than ten seconds), the first analysis 122 may give a smaller weight to the program information 133 when performing the first analysis 122. When the first period of time 134 is relatively long (e.g. more than ten seconds), the first analysis 122 may give a larger weight to the program information 133 when performing the first analysis 122. When the first period of time 134 is even longer (e.g. more than twenty seconds), the first analysis 122 may give an even larger weight to the program information 133 when performing the first analysis 122. To illustrate, the user may view the program information 133 for fifteen seconds and view the preview 135 for forty-five seconds. In this example, the program information 133 may be given a weight of twenty-five percent because the user spent twenty-five percent of the time (fifteen divided by the sum of fifteen and forty-five) viewing the program information 133. The preview 135 may be given a weight of seventy-five percent because the user spent seventy-five percent of the time (forty-five divided by the sum of fifteen and forty-five) viewing the preview 135.

The first analysis 122 may identify that the set-top box device 102 received the preview command 117 and may identify that the preview 135 was displayed at the display device 110 for the second period of time 134 after the set-top box device 102 received the preview command 117. The second period of time 136 may be used to determine a weight given to the preview 135 when performing the first analysis 122. For example, when the second period of time 136 is relatively short (e.g. less than ten seconds), the first analysis 122 may give a smaller weight to the preview 135 when performing the first analysis 122. When the second period of time 136 is relatively long (e.g. more than ten seconds), the first analysis 122 may give a larger weight to the preview 135 when performing the first analysis 122.

The set-top box device 102 may identify a second portion 127 of the EPG 112 based on the first analysis 122. A second content type 131 may be associated with the second portion 127 of the EPG 112. The second content type 131 may be similar to the first content type 130. The set-top box device 102 may modify the EPG 112 to display the second portion 127 of the EPG 112 adjacent to a location of the first portion 126 of the EPG 112. For example, when the first portion 126 of the EPG 112 is located at channel 3, the set-top box device 102 may modify the EPG 112 to display the second portion 127 of the EPG 112 at a location adjacent to channel 3 of the EPG 112.

The set-top box device 102 may determine second interaction data 120 based on user interaction with the second portion 127 of the EPG 112. For example, after the second portion 127 of the EPG 112 is displayed adjacent to a location of the first portion 126 of the EPG 112, the user may interact with the second portion 127 of the EPG 112. To illustrate, the user may select a command to display program information or a preview associated with the second interaction data 120. The set-top box device 102 may perform a second analysis 124 based on one or more of the first interaction data 114, the second interaction data 120, the first portion 126 of the EPG 112, the second portion 127 of the EPG 112, and the first analysis 122. Based on the second analysis 124, the set-top box device 102 may identify a third portion 128 of the EPG 112. A third content type 132 may be associated with the third portion 128 of the EPG 112. The third content type 132 may be similar to one or more of the first content type 130 and the second content type 131.

Thus, by performing the first analysis 122 and the second analysis 124, the set-top box device 102 can identify the second portion 127 and the third portion 128 of the EPG 112 and modify the display device 110 to locate the portions 127-128 adjacent to a location of the first portion 126 of the EPG 112. The set-top box device 102 can quickly identify program content that is similar to the first content type 130 associated with the first portion 126 of the EPG 112 without the user having to search through the EPG 112.

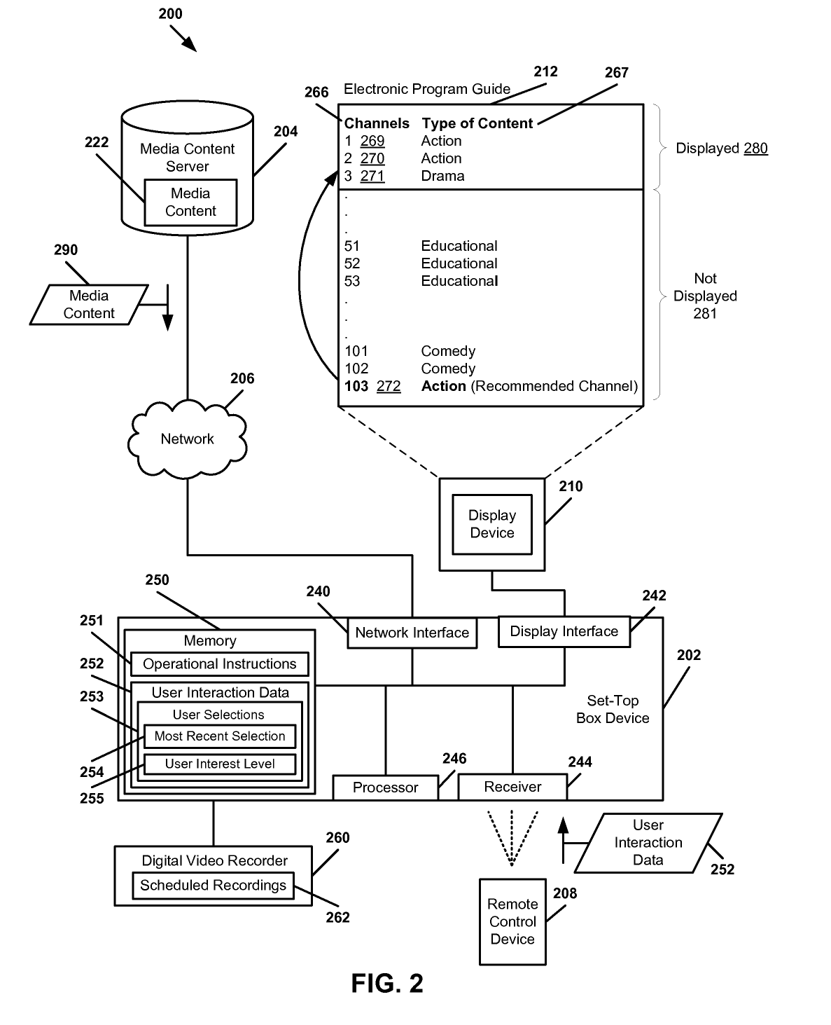

Referring to FIG. 2, a block diagram of a second particular embodiment of a system to modify an electronic program guide is depicted and generally designated 200. The system 200 includes a set-top box device 202 coupled to a media content server 204 via a network 206.

The media content server 204 may send media content 290 to the set-top box device 202 via the network 206. The media content 290 may include television programming content, movie content, video-on-demand content, over-the-top content, other media content, or any combination thereof. The network 206 may receive the media content 290 from the media content server 204 and may send the media content 290 to the set-top box device 202.

The set-top box device 202 includes a network interface 240, a display interface 242, a receiver 244, a processor 246, and a memory 250. The memory 250 may include operational instructions 251 that are executable by the processor 246 to perform various functions of the set-top box device 202. The set-top box device 202 is coupled to a display device 210 via the display interface 242. The set-top box device 202 is coupled to the network 206 via the network interface 240. A digital video recorder 260 is coupled to or integrated with the set-top box device 202. The digital video recorder 260 may include one or more scheduled recordings 262. The set-top box device 202 may display the media content 290 received from the media content server 204 at the display device 210. Particular channels of an Electronic Program Guide (EPG) 212 may be displayed 280 at the display device 210 by the set-top box device 202. Other channels of the Electronic Program Guide (EPG) 212 may be not displayed 281 at the display device 210 by the set-top box device 202. The set-top box device 202 may receive user interaction data 252 at the receiver 244 from a remote control device 208. In response to receiving the user interaction data 252, the set-top box device 202 may modify a portion of the EPG 212 displayed 280 at the display device 210.

The EPG 212 may enable a user to select a part of the media content 290 that is of interest to the user via the remote control device 208. For example, using the remote control device 208, the user may select a channel to display at the display device 210.

In operation, the operational instructions 251 may be executed by the processor 246 to display one or more channels of the EPG 212 at the display device 210. The operational instructions 251 may be executed by the processor 246 to determine the user interaction data 252 associated with displaying the one or more channels of the EPG 212. The user interaction data 252 may include user selections 253, such as a most recent user selection 254. The user interaction data 252 may indicate a user interest level 255 associated with at least one of the channels of the EPG 212. For example, the user interest level 255 may be determined based on a type of content 267 associated with at least one of the channels of the EPG 212. The user interest level 255 may be determined based on one or more of the type of content 267 that is selected for display at the display device 210, the type of content 267 that is not selected for display at the display device 210, and the scheduled recordings 262 at the digital video recorder 260.

In a particular embodiment, a predetermined number of the user selections 253 may be used to identify a recommended channel 272 (e.g. channel one-hundred-three) of the channels of the electronic program guide based on the user interaction data 252. For example, the recent user selections 253 may include data associated with the most recent user selection 254. The operational instructions 251 may be further executed by the processor 246 to modify the EPG 212 to relocate the recommended channel 272 (e.g. channel one-hundred-three) adjacent to a location of one of the displayed channels. For example, channel one 269, channel two 270, and channel three 271 of the EPG 212 may be displayed at the display device 210. The user interaction data 252 may indicate that the recent user selections 253 include selecting and viewing channel one 269 then selecting and viewing channel two 270. In this example, channel two 270 is the most recent user selection 254. Based on the user interaction data 252, the recommended channel 272 may be identified because the type of content 267 (e.g. “action”) of the recommended channel 272 is similar to the type of content 267 (e.g. “action”) of the channels 269-270 that the user had recently selected for viewing. The EPG 212 may be modified to relocate the recommended channel 272 adjacent to channel one 269 or channel two 270. A predetermined number of the recent user selections 253 may be used to identify the recommended channel 272.

Thus, the set-top box device 202 may identify the recommended channel 272 based on the user interaction data 252 that indicates user interaction with channels 269-270. The set-top box device 202 may modify the EPG 212 to relocate the recommended channel 272 adjacent to a location of one or more of the channels 269-270. The recommended channel 272 may have a type of content that is similar to the displayed channels 269-270 (e.g. “action”). In this way, the set-top box device 202 may locate the recommended channel 272 adjacent to a location of one or more of the displayed channels 269-270 without the user having to search through portions of the EPG 112 that are not displayed 281.

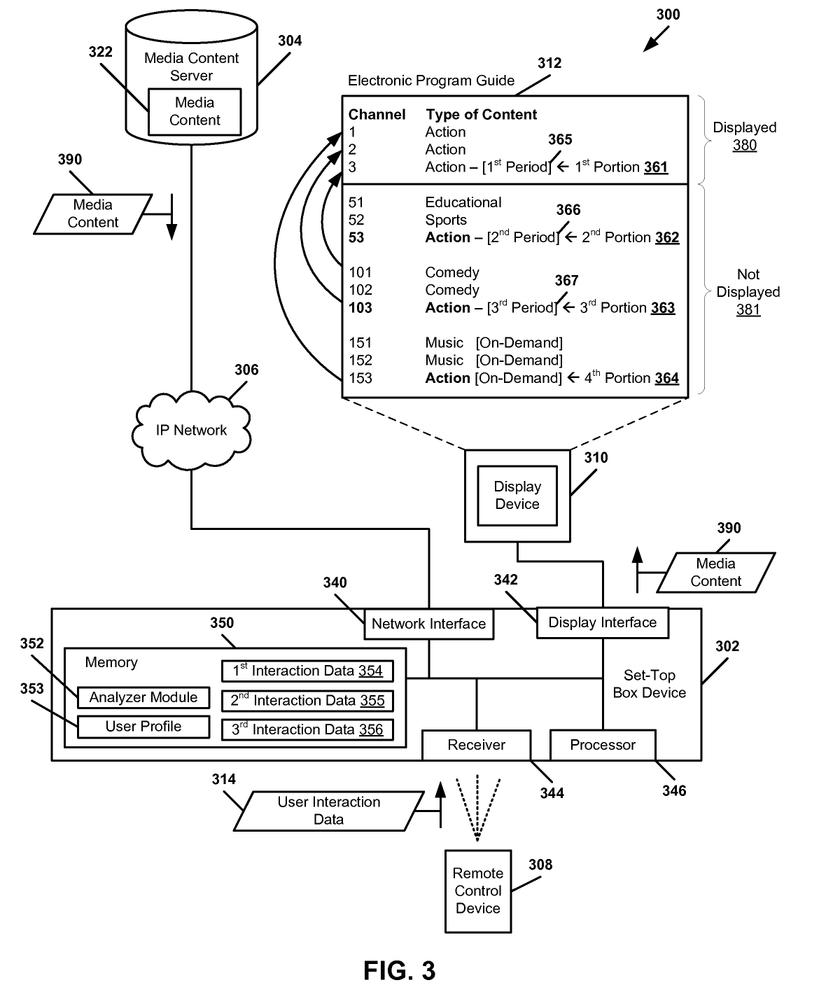

Referring to FIG. 3, a block diagram of a third particular embodiment of a system to modify an electronic program guide is depicted and generally designated 300. The system 300 includes a set-top box device 302 coupled to a media content server 304 via a network 306.

The media content server 304 may send media content 390 to the set-top box device 302 via the network 306. The media content 390 may include television programming content, movie content, video-on-demand content, over-the-top content, other media content, or any combination thereof.

The network 306 may include one or more transmission media, such as fiber-optic cable, Hybrid Fiber Coaxial (HFC) cable, twisted pair cable, wireless transmission media (e.g. 802.11 or 802.16), other transmission media, or any combination thereof. The network 306 may receive the media content 390 from the media content server 304 and may send the media content 390 to the set-top box device 302. In a particular embodiment, the network 306 is an Internet Protocol (IP) based network.

The set-top box device 302 may be coupled to a display device 310. The set-top box device 302 may display the media content 390 at the display device 310. A user (not shown) may interact with the set-top box device 302 via a remote control device 308. Particular portions (e.g. channels 1, 2, and 3) of an Electronic Program Guide (EPG) 312 may be displayed 380 at the display device 310 by the set-top box device 302. Other portions (e.g. channels 51-53, 101-103, and 151-153) of the EPG 312 may be not displayed 381 at the display device 310. The remote control device 308 may send user interaction data 314 to the set-top box device 302 when the user is interacting with the EPG 312.

The set-top box device 302 includes a network interface 340, a display interface 342, a receiver 344, a processor 346, and a memory 350. The memory 350 includes an analyzer module 352 that is executable by the processor 346 to perform various functions of the set-top box device 302. The set-top box device 302 is coupled to a display device 310 via the display interface 342. The set-top box device 302 is coupled to the network 306 via the network interface 340. The set-top box device 302 may display media content 390 received from the media content server 304 at the display device 310. The set-top box device 302 may receive the user interaction data 314 at the receiver 344 from the remote control device 308. The set-top box device 302 may initially display portions of the EPG 312 at the display device 310 based on a user profile 353. In a particular embodiment, the set-top box device 302 modifies the EPG 312 that is displayed at the display device 310 based on the user interaction data 314 and not based on the user profile 353. The set-top box device 302 may modify the user profile 353 based on the user interaction data 314.

In operation, the set-top box device 302 may receive the user interaction data 314 via the remote control device 308. The user interaction data 314 may include various selections associated with navigating the EPG 312, such as displaying information associated with a particular portion of the EPG 312, displaying a preview associated with a particular portion of the EPG 312, scheduling a recording associated with a particular portion of the EPG 312, another interaction indicating an interest in a particular portion of the EPG 312, or any combination thereof. The set-top box device 302 may determine first interaction data 354 based on a first period of user interaction 365 with a first portion 361 (e.g. channels one, two, and three) of the EPG 312. The set-top box device 302 may identify a second portion 362 (e.g. channel fifty-three) of the EPG 312 based on the first interaction data 354. The set-top box device 302 may modify the EPG 312 to display the second portion 362 of the EPG 312 adjacent to a location of the first portion 361 of the EPG 312. For example, in FIG. 3, the set-top box device 302 may modify the EPG 312 to display channel fifty-three adjacent to one of channels one, two, and three.

The set-top box device 302 may identify second interaction data 355 based on a second period of user interaction 366 associated with displaying the second portion 362 of the EPG 312. The set-top box device 302 may identify a third portion 363 (e.g. channel one hundred and three) of the EPG 312 based on one or more of the first interaction data 354, the second interaction data 355, the first portion 361 of the EPG 312, and the second portion 362 of the EPG 312. The set-top box device 302 may modify the EPG 312 to display the third portion 363 of the EPG 312 adjacent to a location of one of the first portion 361 and the second portion 362 of the EPG 312.

The set-top box device 302 may identify third interaction data 356 based on displaying the third portion 363 of the EPG 312. The set-top box device 302 may identify a fourth portion 364 (e.g. channel one hundred and fifty-three) of the EPG 312 based on one or more of the first interaction data 354, the second interaction data 355, the third interaction data 356, the first portion 361 of the EPG 312, the second portion 362 of the EPG 312, and the third portion 363 of the EPG 312. The set-top box device 302 may modify the EPG 312 to display the fourth portion 364 of the EPG 312 adjacent to a location of one of the first portion 361, the second portion 362, and the third portion 363 of the EPG 312. At least one of the portions 361-364 of the EPG 312 may include on-demand media content. The third user interaction data 356 may be determined based on the user interaction data 314 associated with displaying previews of the on-demand media content within a particular time period.

Thus, the set-top box device 302 can identify the portions 362-364 of the EPG 312 based on the periods of user interaction 365-367 and display the portions 362-364 adjacent to the first portion 361 of the EPG 312. By doing so, the set-top box device 302 can display media content that may be similar to the type of media content that the user has shown an interest in viewing without the user having to search the EPG 312 to find the similar media content.

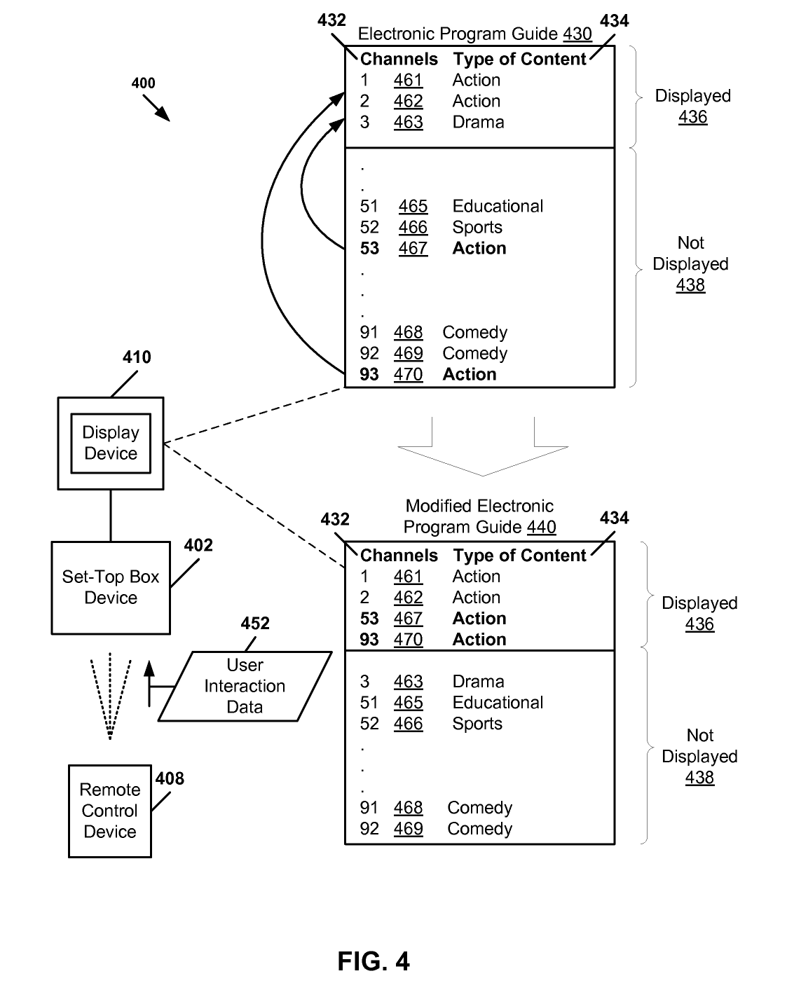

Referring to FIG. 4, a block diagram of a fourth particular embodiment of a system to modify an electronic program guide is depicted and generally designated 400. The system 400 includes a set-top box device 402 coupled to display device 410.

The set-top box device 402 may initially display portions of an Electronic Program Guide (EPG) 430 at the display device 410. The EPG 430 may include channels 432. Each of the channels 432 may have an associated type of content 434. At a particular time, portions of the EPG 430 (e.g. channel one 461, channel two 462, and channel three 463) may be displayed 436 at the display 410. Other portions of the EPG 430 (e.g. channels fifty-one 465, fifty-two 466, fifty-three 467, ninety-one 468, ninety-two 469, and ninety-three 470) may be not displayed 438 at the display 410.

In operation, portions of the EPG 430 may be displayed 436 at the display device 410 by the set-top box device 402. The set-top box device 402 may receive user interaction data 452 via a remote control device 408. The set-top box device 402 may identify one more channels of the EPG 430 based on the user interaction data 452. For example, the user interaction data 452 may indicate user interaction with the channels 461 and 462. The set-top box device 402 may identify that the channels fifty-three 467 and ninety-three 470 are similar to channels 461-462. For example, the channels 467 and 470 may have the type of content 434 that is similar to the type of content 434 of the channels 461 and 462. The set-top box device 402 may modify the EPG 430 to create a modified EPG 440. The modified EPG 440 may relocate at least one of the identified channels 467 and 470 adjacent to one of the channels 461 and 462. The set-top box device 402 may display the modified EPG 430 at the display device 410 instead of the EPG 430.

Thus, the set-top box device 402 may identify the channels 467 and 470 based on the user interaction data 452 and modify the EPG 430 to display at least one of the identified channels 467 and 470 adjacent to one of the channels 461 and 462. In this way, the set-top box device 402 may relocate the identified channels 467 and 470 adjacent to the channels 461 and 462 when the identified channels 467 and 470 have the type of content 434 that is similar to the type of content 434 of the channels 461 and 462.

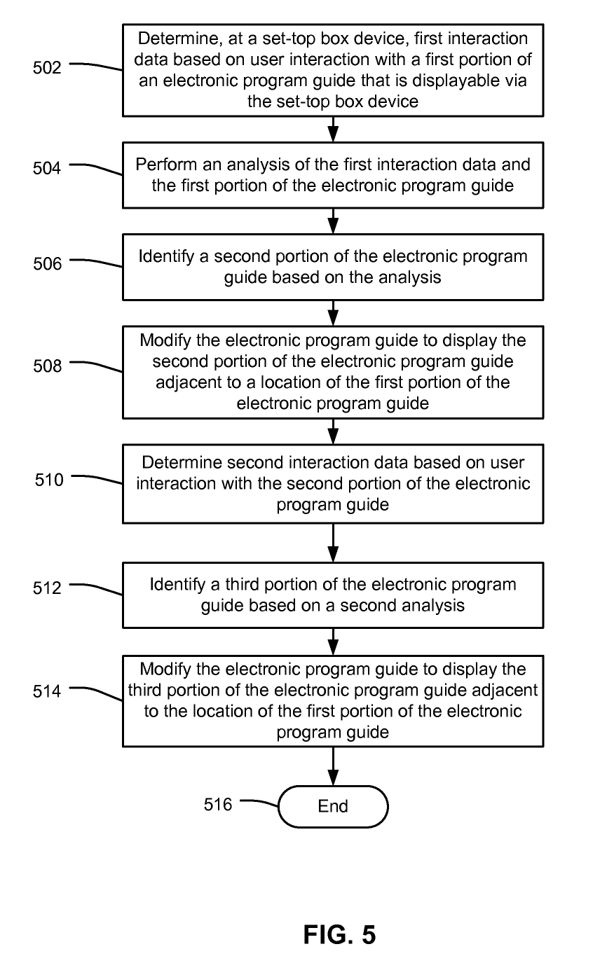

FIG. 5 is a flow diagram of a first particular embodiment of a method to modify an electronic program guide. The method may be performed by the set-top box device 102 of FIG. 1, the set-top box device 202 of FIG. 2, the set-top box device 302 of FIG. 3, or the set-top box device 402 of FIG. 4.

First interaction data is determined at a set-top box device based on user interaction with a first portion of an electronic program guide that is displayable via the set-top box device, at 502. Moving to 504, an analysis is performed of the first interaction data and of the first portion of the electronic program guide. Advancing to 506, a second portion of the electronic program guide is identified based on the analysis. Continuing to 508, the electronic program guide is modified to display the second portion of the electronic program guide adjacent to a location of the first portion of the electronic program guide. For example, in FIG. 1, the set-top box device 102 may receive the first interaction data 114 and perform the first analysis 122. The set-top box device 102 may identify the second portion 127 of the EPG 112 and modify the EPG 112 to display the second portion 127 adjacent to a location of the first portion 126 of the EPG 112.

Moving to 510, second interaction data may be determined based on user interaction with the second portion of the electronic program guide. Proceeding to 512, a third portion of the electronic program guide may be identified based on a second analysis. Moving to 514, the electronic program guide may be modified to display the third portion of the electronic program guide adjacent to the location of the first portion of the electronic program guide. For example, in FIG. 1, the set-top box device 102 may perform the second analysis 124 based on the second interaction data 120. The set-top box device 102 may identify the third portion 128 of the EPG 112 based on the second analysis 124. The set-top box device 102 may modify the EPG 112 to display the third portion 128 adjacent to the first portion 126 of the EPG 112. The method ends at 516.

Thus, a set-top box device can analyze user interaction data associated with a first portion of an electronic program guide and identify a second portion of the electronic program guide that has a type of content similar to the first portion of the electronic program guide. The set-top box device can modify the electronic program guide to display the second portion adjacent to the first portion of the electronic program guide to enable a user to view the second portion without having to search through the electronic program guide to find similar content.

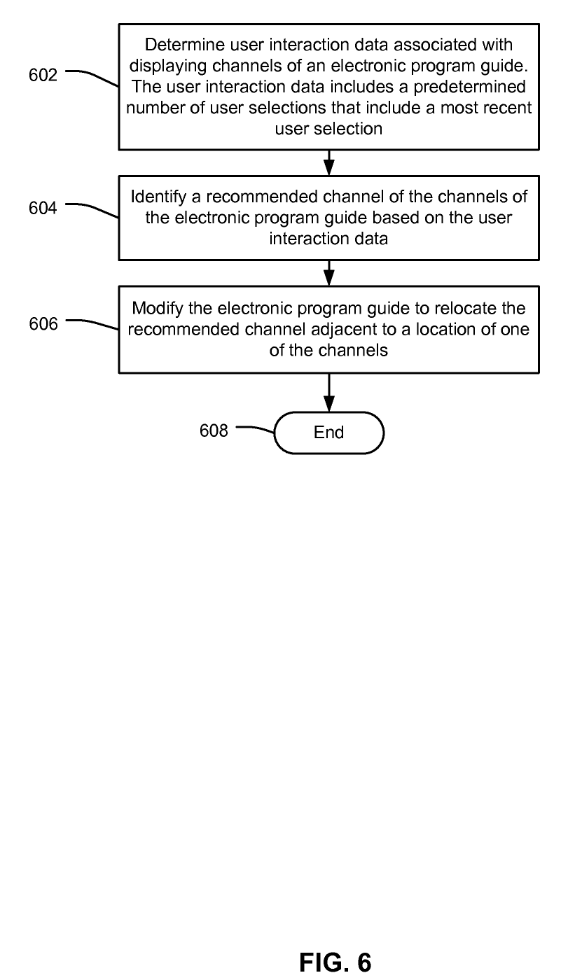

FIG. 6 is a flow diagram of a second particular embodiment of a method to modify an electronic program guide. The method may be performed by the set-top box device 102 of FIG. 1, the set-top box device 202 of FIG. 2, the set-top box device 302 of FIG. 3, or the set-top box device 402 of FIG. 4.

User interaction data associated with displaying channels of an electronic program guide is determined, at 602. The user interaction data includes a predetermined number of user selections that include a most recent user selection. Moving to 604, a recommended channel of the channels of the electronic program guide is identified based on the user interaction data. Proceeding to 606, the electronic program guide is modified to relocate the recommended channel adjacent to a location of one of the channels. For example, in FIG. 2, the set-top box device 202 determines the user interaction data 252 associated with displaying the channels 266 of the EPG 212. The set-top box device 202 identifies the recommended channel 272 based on the user interaction data 252. The set-top box device 202 modifies the EPG 212 to relocate the recommended channel 272 adjacent to one of the channels 269 and 270. The method ends at 608.

Thus, a set-top box device may identify a recommended channel based on user interaction data associated with displaying channels of an electronic program guide. The set-top box device may modify the electronic program guide to relocate the recommended channel adjacent to a location of one of the displayed channels. In this way, the set-top box device can relocate the recommended channel adjacent to a location of one of the displayed channels without the user having to search through portions of the electronic program guide that are not displayed.

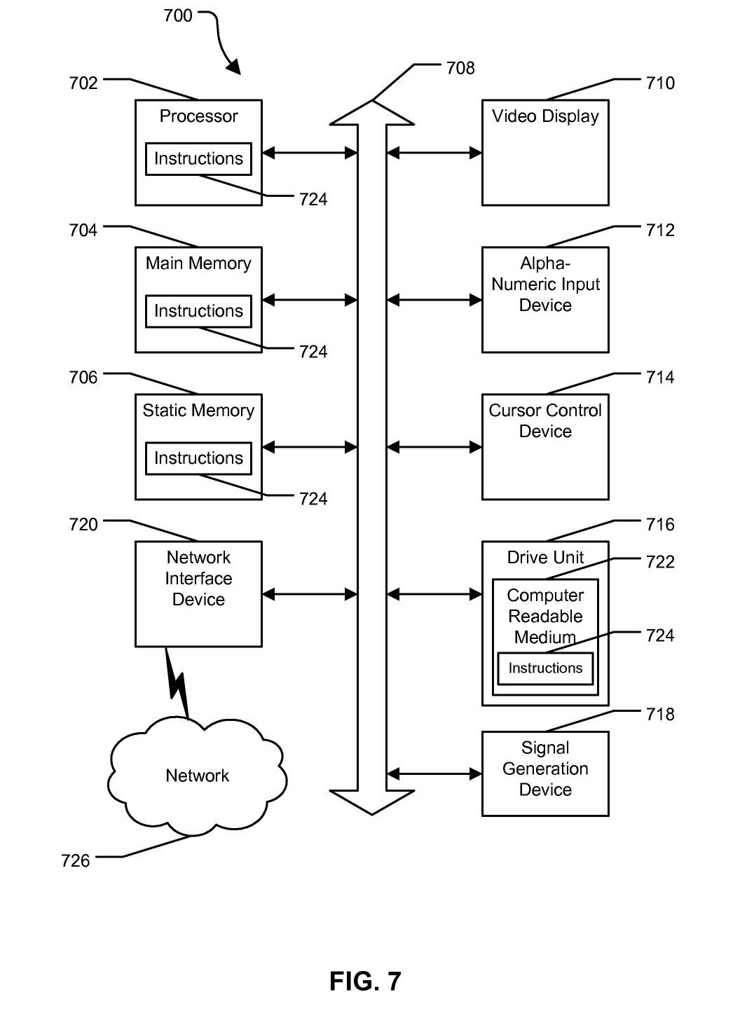

Referring to FIG. 7, an illustrative embodiment of a general computer system is shown and is designated 700. The computer system 700 can include a set of instructions that can be executed to cause the computer system 700 to perform any one or more of the methods or computer based functions disclosed herein. The computer system 700, or any portion thereof, may operate as a standalone device or may be connected, e.g., using a network, to other computer systems or peripheral devices. The computer system 700 may be used to implement the set-top box device 102 of FIG. 1, the set-top box device 202 of FIG. 2, the set-top box device 302 of FIG. 3, or the set-top box device 402 of FIG. 4.

In a networked deployment, the computer system 700 may operate in the capacity of a set-top box device, a residential gateway, or a server, such as a media content server as described above with reference to FIG. 1-4. The computer system 700 can also be implemented as or incorporated into various devices, such as a personal computer (PC), a tablet PC, a personal digital assistant (PDA), a mobile device, a palmtop computer, a laptop computer, a desktop computer, a communications device, a wireless telephone, a personal trusted device, a web appliance, or any other machine capable of executing a set of instructions (sequential or otherwise) that specify actions to be taken by that machine. In a particular embodiment, the computer system 700 can be implemented using electronic devices that provide voice, video or data communication. Further, while a single computer system 700 is illustrated, the term “system” shall also be taken to include any collection of systems or sub-systems that individually or jointly execute a set, or multiple sets, of instructions to perform one or more computer functions.

As illustrated in FIG. 7, the computer system 700 may include a processor 702, e.g., a central processing unit (CPU), a graphics-processing unit (GPU), or both. Moreover, the computer system 700 can include a main memory 704 and a static memory 706 that can communicate with each other via a bus 708. As shown, the computer system 700 may further include a video display unit 710, such as a liquid crystal display (LCD), an organic light emitting diode (OLED), a flat panel display, a solid-state display, or a cathode ray tube (CRT). Additionally, the computer system 700 may include an input device 712, such as a keyboard, and a cursor control device 714, such as a mouse. The computer system 700 can also include a disk drive unit 716, a signal generation device 718, such as a speaker or remote control, and a network interface device 720.

In a particular embodiment, as depicted in FIG. 7, the disk drive unit 716 may include a computer-readable medium 722 in which one or more sets of instructions 724, e.g. software, can be embedded. Further, the instructions 724 may embody one or more of the methods or logic as described herein. In a particular embodiment, the instructions 724 may reside completely, or at least partially, within the main memory 704, the static memory 706, and/or within the processor 702 during execution by the computer system 700. The main memory 704 and the processor 702 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 724 or receives and executes instructions 724 responsive to a propagated signal, so that a device connected to a network 726 can communicate voice, video or data over the network 726. Further, the instructions 724 may be transmitted or received over the network 726 via the network interface device 720.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any tangible storage medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any one or more of a computer-readable medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal including computer instructions.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, MPEG, SMPTE, and H.264) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

In the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the present disclosure. Thus, to the maximum extent allowed by law, the scope of the disclosure is to be determined by the broadest permissible interpretation of the following claims and their equivalents, and shall not be restricted or limited by the foregoing detailed description.

What is claimed is:

1. A computer-implemented method, comprising:
determining, at a set-top box device, first interaction data based on user interaction with a first portion of an electronic program guide that is displayable via the set-top box device;
performing an analysis of the first interaction data and the first portion of the electronic program guide;
identifying a second portion of the electronic program guide based on the analysis; and
modifying the electronic program guide to display the second portion of the electronic program guide adjacent to a location of the first portion of the electronic program guide.

2. The computer-implemented method of claim 1, wherein the first interaction data includes data indicating selection of an information command associated with the first portion of the electronic program guide, wherein the information command causes program information associated with the first portion of the electronic program guide to be displayed.

3. The computer-implemented method of claim 2, wherein the first interaction data includes a measurement of a first period of time that the program information associated with the first portion of the electronic program guide is displayed.

4. The computer-implemented method of claim 1, wherein the first interaction data includes data indicating selection of a preview command associated with the first portion of the electronic program guide, wherein the preview command causes a preview associated with the first portion of the electronic program guide to be displayed.

5. The computer-implemented method of claim 4, wherein the first interaction data includes a measurement of a second period of time that the preview associated with the first portion of the electronic program guide is displayed.

6. The computer-implemented method of claim 1, wherein the first interaction data includes a type of content displayed at the first portion of the electronic program guide.

7. The computer-implemented method of claim 6, wherein the second portion of the electronic program guide has the same type of content as the first portion of the electronic program guide.

8. The computer-implemented method of claim 1, further comprising:
determining second interaction data based on user interaction with the second portion of the electronic program guide;
identifying a third portion of the electronic program guide based on a second analysis; and
modifying the electronic program guide to display the third portion of the electronic program guide adjacent to the location of the first portion of the electronic program guide.

9. The computer-implemented method of claim 8, wherein the second analysis is based on the second interaction data and based on the second portion of the electronic program guide.

10. The computer-implemented method of claim 8, wherein the second analysis is based on one or more of the first interaction data, the second interaction data, the first portion of the electronic program guide, and the second portion of the electronic program guide.

11. A set-top box device, comprising:
a processor; and
a computer-readable storage medium comprising operational instructions that, when executed by the processor, cause the processor to:
determine user interaction data comprising first data associated with displaying channels of an electronic program guide, the user interaction data including a predetermined number of user selections that include a most recent user selection;
identify a recommended channel of the electronic program guide based on the user interaction data; and
modify the electronic program guide to relocate the recommended channel adjacent to a location of one of the displayed channels.

12. The set-top box device of claim 11, wherein the user interaction data further comprises second data associated with scheduling media content for recording via the electronic program guide.

13. A set-top box device, comprising:
a network interface to receive media content from a media content server;
a display interface to send the media content to a display device and to display an electronic program guide based on a user profile; and
a computer-readable storage medium including an analyzer module that when executed by a processor, causes the processor to determine first interaction data based on a first period of user interaction with a first portion of the electronic program guide, to identify a second portion of the electronic program guide based on the first interaction data, and to modify the electronic program guide to display the second portion of the electronic program guide adjacent to a location of the first portion of the electronic program guide.

14. The set-top box device of claim 13, wherein the analyzer module is further executable by the processor to modify the user profile based on the first interaction data.

15. The set-top box device of claim 13, wherein the analyzer module is further executable by the processor to identify second interaction data based on a second period of user interaction associated with displaying the second portion of the electronic program guide, to identify a third portion of the electronic program guide based on the first portion and the second portion of the electronic program guide, and to modify the electronic program guide to display the third portion of the electronic program guide adjacent to a location of one of the first portion and the second portion of the electronic program guide.

16. The set-top box device of claim 15, wherein the analyzer module is further executable by the processor to identify third interaction data based on displaying the third portion of the electronic program guide.

17. The set-top box device of claim 16, wherein the analyzer module is further executable by the processor to identify a fourth portion of the electronic program guide based on the second portion and the third portion of the electronic program guide.

18. The set-top box device of claim 17, wherein the analyzer module is further executable by the processor to modify the electronic program guide to display the fourth portion of the electronic program guide adjacent to a location of one of the first portion, the second portion, and the third portion of the electronic program guide.

19. The set-top box device of claim 17, wherein the fourth portion of the electronic program guide includes on-demand media content.

20. The set-top box device of claim 19, wherein the third interaction data is determined based on a user interaction associated with displaying previews of the on-demand media content within a particular time period.
